(19) United States
(12) Patent Application Publication
(10) Pub. No.: US 2013/0065059 A1
(43) Pub. Date: Mar. 14, 2013

(54) METHOD OF ADHERING IONOMER TO METAL

(71) Applicants: Benjamin Andrew Smillie, Kingston (CA); Lorenzo Fred Pelosi, Wilmington, DE (US)

(72) Inventors: Benjamin Andrew Smillie, Kingston (CA); Lorenzo Fred Pelosi, Wilmington, DE (US)

(73) Assignee: E. I. DU PONT DE NEMOURS AND COMPANY, Wilmington, DE (US)

(21) Appl. No.: 13/413,186

(22) Filed: Mar. 6, 2012

Related U.S. Application Data
(60) Provisional application No. 61/449,756, filed on Mar. 7, 2011.

(51) Int. Cl. B05D 7/14; F16L 9/00; B32B 27/08; B32B 7/12; B32B 15/092; B32B 1/08

(52) U.S. Cl. CPC B05D 7/14; B32B 15/092; B32B 1/08; B32B 27/08; B32B 7/12; F16L 9/00
USPC 428/416; 427/379; 138/140

(57) ABSTRACT

Disclosed is a method of bonding ionomer compositions to metal using partially cured epoxy primers. The method is useful for preparing highly abrasion-resistant tubular articles such as pipes comprising ionomer liner layers.

### CROSS-REFERENCE TO RELATED APPLICATION

This application claims the benefit of U.S. Provisional application No. 61/449,756, filed Mar. 7, 2011.

### FIELD OF THE INVENTION

The invention relates to a method of bonding ionomer compositions to metal using an epoxy primer.

### BACKGROUND OF THE INVENTION

Mining operations require the transport of highly abrasive particulate or slurry streams. The recovery of bitumen from oil sands is becoming increasingly important in the energy industry. Processing oil sand includes transporting and conditioning the oil sand as aqueous slurry over kilometer lengths of pipe up to one meter or more in diameter. Often, metal pipes such as carbon steel or cast iron pipes are used for the transport of these highly abrasive streams of oil sand slurry. They are expensive, heavy and only provide a temporary solution since they are eventually destroyed. To increase their lifetimes, the metal pipes may be rotated 90 degrees on their axes on a regular basis to provide new transport surfaces. However, because of the pipe weight, this rotation is difficult and ultimately the entire pipe is worn out and must be replaced.

Use of plastic pipes, pipe liners and pipe coatings has been proposed to reduce these shortcomings. U.S. Patent Application Publications 2009/0107572 and 2009/0107553 describe abrasion resistant ionomer lined steel pipes. References to other plastic pipe liners and methods for lining a pipe with a polymeric liner can be found in those publications.

In some cases, additional materials have been used to adhere polymeric pipe liners to metal pipes. Japanese Patent Application JP2000179752 discloses the use of epoxy primers to adhere ionomer tubes to water service metal pipes. The methods described therein involve either preheating the pipe prior to coating with epoxy or post-coating heating to cure the epoxy. Heating the pipe to cure the epoxy adds to the complexity and expense to prepare the steel pipe for bonding to the ionomer liner.

U.S. Patent Application Publication 2010/0009086 discloses a rapid-cure epoxy coating system for protecting the exterior of pipes.

Because of the extreme conditions that ionomer-lined pipes experience during hydroslurry operations, good adhesion of the liner to the metal pipe casing is important. Therefore, it is desirable to develop methods for preparing lined pipe with improved adhesion between the substrate and liner. It is also desirable that such methods minimize the need to heat the pipe to cure the primer used to adhere the liner to the pipe.

### SUMMARY OF THE INVENTION

The invention provides a method for bonding ionomer compositions to a metal substrate comprising:

(a) providing a metal substrate;

(b) providing an epoxy composition;

(c) coating the metal substrate with the epoxy composition;

(d) partially curing the epoxy composition at ambient temperature for a period of time sufficient to produce a layer of partially cured epoxy composition that exhibits an exotherm below 150° C. when heated, determined by differential scanning calorimetry according to ASTM D3417;

(e) contacting the layer of partially cured epoxy composition with an ionomer composition to provide a multilayer overlay;

wherein the ionomer composition comprises an E/X/Y copolymer where E represents copolymerized units of ethylene, X is present in an amount of about 2 to about 30 weight % of the E/X/Y polymer and represents copolymerized units of a C₃₋₈ α,β-ethylenically unsaturated carboxylic acid, preferably acrylic acid or methacrylic acid, and Y is present in from 0 to 45 weight % of the E/X/Y copolymer and represents copolymerized units of a softening comonomer selected from alkyl acrylate or alkyl methacrylate, wherein the alkyl groups have from 1 to 8 carbon atoms, or vinyl acetate, and wherein at least a portion of the carboxylic acid groups in the copolymer are neutralized to salts containing alkali metal cations, alkaline earth metal cations, transition metal cations, or combinations of two or more of these metal cations;

(f) applying heat and optionally pressure to raise the temperature of the multilayer overlay to at least 50° C. above the melt temperature of the ionomer thereby achieving intimate contact of the ionomer with the partially cured epoxy composition, additionally curing the epoxy composition and bonding the ionomer to the epoxy coated metal substrate.

The invention also provides an article, such as a pipe, comprising

(a) a metal substrate;

(b) an epoxy layer directly adhered to the metal substrate; and

(c) an abrasion resistant multilayer structure comprising an adhesive ionomer layer comprising an ionomer of an ethylene acid terpolymer in contact with and directly adhered to the epoxy layer on the face opposite the metal substrate; an interior layer comprising an ionomer of an ethylene acid dipolymer or a polyethylene homopolymer, polyethylene copolymer, polypropylene homopolymer or polypropylene copolymer; and an abrasion resistant ionomer surface layer comprising an ionomer of an ethylene acid terpolymer.

### DETAILED DESCRIPTION OF THE INVENTION

All publications, patent applications, patents, and other references mentioned herein are incorporated by reference in their entirety.

Although methods and materials similar or equivalent to those described herein can be used in the practice or testing of the present invention, suitable methods and materials are described herein.

Unless stated otherwise, all percentages, parts, ratios, etc., are by weight. When an amount, concentration, or other value or parameter is given as either a range, preferred range or a list of upper preferable values and lower preferable values, this is to be understood as specifically disclosing all ranges formed from any pair of any upper range limit or preferred value and any lower range limit or preferred value, regardless of whether ranges are separately disclosed. Where a range of numerical values is recited herein, unless otherwise stated, the range is intended to include the endpoints thereof, and all integers and fractions within the range. It is not intended that the scope of the invention be limited to the specific values recited when defining a range. When the term “about” is used in describing a value or an end-point of a range, the disclosure includes the specific value or end-point referred to.

As used herein, the terms “comprises,” “comprising,” “includes,” “including,” “containing,” “characterized by,” “has,” “having” or any other variation thereof, are intended to cover a non-exclusive inclusion. The transitional phrase “consisting of” excludes any element, step, or ingredient not specified in the claim, closing the claim to the inclusion of materials other than those recited except for impurities ordinarily associated therewith. The transitional phrase “consisting essentially of” limits the scope of a claim to the specified materials or steps and those that do not materially affect the basic and novel characteristic(s) of the claimed invention. A ‘consisting essentially of’ claim occupies a middle ground between closed claims that are written in a ‘consisting of’ format and fully open claims that are drafted in a ‘comprising’ format.

Where applicants have defined an invention or a portion thereof with an open-ended term such as “comprising,” the description is interpreted to also describe such an invention using the terms “consisting essentially of” or “consisting of.”

Use of “a” or “an” are employed to describe elements and components of the invention. This is done merely for convenience and to give a general sense of the invention. This description includes one or at least one and the singular also includes the plural unless it is obvious that it is meant otherwise.

In describing certain polymers it is to be understood that sometimes applicants are referring to the polymers by the monomers used to make them or the amounts of the monomers used to make them. While such a description may not include the specific nomenclature used to describe the final polymer or may not contain product-by-process terminology, any such reference to monomers and amounts is to be interpreted to mean that the polymer is made from those monomers or that amount of the monomers, and the corresponding polymers and compositions thereof.

The materials, methods, and examples herein are illustrative only and, except as specifically stated, are not intended to be limiting.

As used herein, a “multilayer structure” comprises layers of materials wherein all layers in that structure are bonded or adhered to the layers they are in contact with. A multilayer ionomer structure, such as a film, sheet or tube, has at least one surface layer that comprises an ionomer composition. When a multilayer structure is in tubular form, the “outermost” layer is the surface layer facing the outside of the tube, and the “innermost” surface layer faces the inside of the tube. “Interior” layers are not surface layers. As used herein for multilayer structures, “adhesive” and “adhesive layer” refer to ionomer compositions and layers that are in contact with the epoxy composition used to adhere the ionomer to the metal. The term “wear layer” refers to the layer that is farthest from the metal substrate and functions as an abrasion resistant surface protecting the metal from abrasion. The term “tie layer” refers to a layer that facilitates adherence between two other layers in a multilayer structure.

To minimize the cost of epoxy coating the steel pipe it is desirable to use an epoxy that can be applied to the prepared steel pipe (sandblasted to white metal) at ambient temperature and requires no preheating or post heating of the steel to achieve a hard durable surface finish. As used herein, “ambient temperature” means that no heating or cooling is applied to the coated substrate beyond what is prevailing in the environment around the coated substrate. The temperature may be from about 0° C. to about 40° C., preferably from about 20° C. to about 30° C. Since the ionomer liner may be applied to the inside of steel pipes, it is important to develop a strong bond at the lowest possible interface temperature between epoxy and ionomer to prevent drooping or flow of the liner due to the pull of gravity. The epoxy primer desirably provides a strong thermally activated bond to the ionomer liner at an interface temperature between epoxy and ionomer that is higher than the melting point of the ionomer liner composition (about 90° C.), but less than a temperature at which the melt viscosity of the liner composition is so low that it would start to flow.

Surprisingly, we have found that certain epoxy compositions provide significantly better bonds than other epoxy combinations when used as a primer to bond an ionomer liner to epoxy coated steel. These epoxy compositions are characterized by exhibiting an exotherm below 150° C. when heated above the glass transition temperature (Tg), determined by differential scanning calorimetry according to ASTM D3417 and wherein the epoxy coating can further cure during the thermal bonding step between epoxy coated steel pipe and the ionomer.

The compositions and methods described herein can be used to provide metal protected against abrasion by long lifetime, highly abrasion-resistant ionomer liners. Applications include ionomer lined pipes for a wide variety of mining and other transportation uses over a wide range of environmental conditions. High burst strength may be another attribute of the pipes.

The first step of the method comprises providing a metal substrate.

Preferably, the metal substrate comprises carbon steel, steel, stainless steel, cast iron, galvanized steel, aluminum, copper and the like. The substrate may take any form known in the art and can be in any shape, such as sheets, tubes, pipes, and irregularly shaped objects.

For example, the substrate may be a molded or shaped article, such as a tool, headlamp housing, light fixture, sign, sheet, and the like. The substrate may be substantially planar, comprising two opposed faces with large surface areas and a relatively small thickness in relation to the faces. A notable substrate is a metal pipe, including one that has an inner surface that needs protection from abrasion.

More preferably the metal pipe comprises carbon steel to provide the physical properties required for the material conveying processes contemplated herein. For oil slurry transport, the large diameter steel pipes may be certified to meet certain National and International Pipe standards & Specifications, for example ASTM (American Society for Testing and Materials) A672/A672M-09 Standard Specification for Electric-Fusion-Welded Steel Pipe for High-Pressure Service at Moderate Temperatures.

The metal pipe may have any dimensions, including thickness, outer diameter, inner diameter and length suitable for the intended use. The pipe may have a hollow, substantially circular profile and the wall thickness may be generally uniform around the circumference of the pipe, or the pipe may have any profile and the wall thickness may vary around the circumference of the pipe as desired. For example but not limitation, the metal pipe may have a thickness of about 6.3 to about 51 mm (about 0.25 to about 2 inches, about 9.5 to about 38 mm (about 0.375 to about 1.5 inches) or about 13 to about 25.4 mm (about 0.5 to about 1 inch). For example but not limitation, the metal pipe may have an outer diameter (OD) of about 5.1 to about 254 cm (about 2 to about 100 inches), about 25.4 to about 152 cm (about 10 to about 60 inches) or about 51 to about 102 cm (about 20 to about 40 inches). For example but not limitation the metal pipe may have a length of about 1.5 to about 12.2 m (about 5 to about 40 feet) or about 3.1 to about 18.3 m (about 10 to about 60 feet). Longer lined pipe lengths are preferred because they minimize the number of connections that must be made in the field. The inner surface of the metal pipe may be treated to provide enhanced adhesion and stability. Such treatments include descaling by sand-, metal grit- or shot-blasting, acid etching, and cleaning the metal surface with solvent or chemical washes to remove grease and/or oxide layers.

The second step of the method comprises providing an epoxy composition.

Constituent components of the epoxy composition may include, but are not limited to, organic resins, chemical activators, as well as other additives that may enhance one or more features of the epoxy coating system. Epoxy coatings include an organic resin and a chemical activator that reacts with the organic resin.

The organic resin is typically a thermosetting polymer, such as, for example, an epoxy. A liquid epoxy is preferred. Preferred epoxies include a reaction product of bisphenol A and epicholorohydrin. These compounds are well-known in the art, as are the chemical processes and mechanisms that are generally involved when these compounds are combined to form the reaction product that is found in the organic resins, e.g., organic resin.

The organic resin may be combined with other components, including filler materials, plasticizers, dyes, and pigments, as desired, to form a base composition.

The chemical activator is a type of catalyzing agent that reacts with the organic resin. Chemical activators are known in the art and are selected to cure the base composition. As used herein, the term “cure” and any derivative term thereof (i.e., “cures,” “cured,” “curing,” “curative,” etc.) refers to a process by which a liquid or semi-solid resin hardens or becomes solidified. Curing may occur with the help of an additive, such as a hardener or catalyst. A mechanism of curing may comprise the crosslinking of polymer molecules, a chemical reaction, a bond formation, introduction of intramolecular forces (such as hydrogen bonds), or any other mechanism of attractive force or structure feasible in the context of the present disclosure. Those having ordinary skill in the art will readily appreciate the function of the chemical activator in this process. So, no additional details will be provided herein of the chemical reactions that occur when a chemical activator is mixed with the organic resin to form the coating.

The chemical activator may be selected to facilitate curing of the coating so as to form a layer with the physical properties discussed herein. Examples of a suitable chemical activator include derivatives of ammonia, e.g., amines, which are compatible with the compound that is selected for use as organic resin. Suitable amines include, for example, diamines that react with the organic resin to create a crosslinked polymer. Aliphatic amine curing agents, including cycloaliphatic amines, are preferred. Amines that can be used as the chemical activator include aminoethylpiperazine, tetraethylene pentamine, alkylamines, and other polyamines that have more than one amine group. A preferred aliphatic amine is the cycloaliphatic amine aminoethylpiperazine. Other preferred amines include polyoxypropylenediamines. Because the two part epoxy will be applied as a liquid it is preferred to use a liquid epoxy (low molecular weight) and chemical activators that are liquids at room temperature. Polyoxypropylenediamines are advantageous to use because they do not pose the skin irritation issues or skin sensitization problems of other amine activators.

The chemical activator composition may include one or more inorganic additives, e.g., filler materials, nitrates, pigments, among others. It may also include organic additives such as, for example, dyes and organic nitrates.

A notable epoxy composition is SP-2888RG, an epoxy/urethane two part epoxy primer sold by Specialty Polymer Coatings, #101 20529 62nd Avenue, Langley BC V3A 8R4.

A notable base resin is EPON 828, an undiluted clear difunctional bisphenol A/epichlorohydrin derived liquid epoxy resin, sold by Hexion Specialty Chemicals, Inc. 180 East Broad Street, Columbus, Ohio 43215 (Hexion). This resin can be mixed with various chemical activators to provide various cure rates.

Notable compositions are substantially free of solvents. The term “substantially free”, as used herein with respect to a composition and a component, refers to a composition that includes no more than an adventitious amount of the component. Stated alternatively, the composition includes no added amount of the component, only the amount that is commonly present in the raw materials from which the composition is produced. In some commercially available materials, the level of adventitious components is less than less than 2.5%, 1.0%, less than 0.5%, or less than 0.1% by weight, based on the weight of the commercially available material.

Solvents may be used to provide a desired viscosity, but are preferably used in minimal amounts. Epoxy coatings may contain substantial amounts of mineral fillers to reduce the tendency of the coating to shrink upon cure. As more filler is added the viscosity of the coating increases unless some solvent is included to reduce viscosity. For spray coating at ambient conditions it may be useful to thin the blend of base and activator with 10 to 30 weight % of solvent to reduce the viscosity so that it will flow through the spray gun apparatus. Suitable solvents are those that will not react with the epoxy base resin and include acetone, methyl ethyl ketone and relatively high boiling solvents such as naphtha dimethyl carbonate and propylene carbonate. Dimethyl carbonate, propylene carbonate and acetone are desirable solvents, since they have low potential for producing greenhouse gases, and according to the EPA do not need to be regulated as volatile organic compounds under the Clean Air Act.

The amount of organic resin and the amount of chemical activator, as well as the amounts of other additives, are selected so as to cause the coating to exhibit one or more of the physical properties discussed herein. For example, the amount of chemical activator and the amount of organic resin may be selected to provide a desirable stoichiometric ratio of amines in the chemical activator to epoxy groups in the liquid epoxy. In some cases, the ratio of organic resin to activator may be adjusted to provide a desired rate of curing as discussed in greater detail below. It is preferable to use an activator that gives strong bonds when added to the epoxy base at or below the stoichiometric ratio of amines in the activator to the epoxy groups in the base. A desirable amount of activator may provide from about 75 to about 100% of equivalent weights of amine to epoxy groups in the epoxy base resin. Excess amounts of activator blended with the base resin were found to deteriorate the bond strength between the epoxy and the steel. Decreasing the amount of activator so there is a deficit of activator amine to react with the epoxy groups in the base in select cases can produce stronger bonds compared to the stoichiometric ratio. However, it is preferred to use an activator base combination that provides strong bonds at the stoichiometric ratio.

An important aspect of the epoxy coating system is that it has a slow cure rate at ambient temperatures. In particular, the epoxy coating desirably remains not fully cured to provide for improved adhesion to the ionomer liner material during the thermal bonding of the liner to the epoxy coated pipe.

In addition to the benefits discussed herein, the coating system exhibits a substantially durable adhesion to metals, metal pipes, and other metallic structures so that it can provide a strong bond of the liner to the metal substrate. For example the liner bonded to the primed steel coating system has 90° t-peel value greater than 356 N/25 mm or 80 lbf/in. Measurement of the bond strength of the epoxy coating to the metal substrate (in the absence of the liner) may be carried out according to ASTM D4541 “Standard Test Method for Pull-Off Strength of Coatings Using Portable Adhesion Testers”.

The coating system is also desirably substantially corrosion and/or chemical-resistant, including resistance to corrosion, resistance to discoloration, resistance to chemical reaction, any other resistance measurement feasible in the context of the present disclosure, or any combination thereof.

The step of providing the epoxy composition may include mixing the constituent components of the base composition to form the coating that is applied to the substrate. In most cases, the base composition and the chemical activator are kept separate until shortly before the coating system is applied to the substrate. This is done to prevent undesired reaction of the components.

Mixing may include manual, automated, and semi-automated techniques and/or mechanisms. Skilled artisans will recognize the wide variety of methods that are applicable to coatings used in embodiments of the coating systems discussed herein. For example, the constituent components may be in two separate component mixtures that are combined in a container, e.g., a bucket, and mixed together by hand stirring. Alternatively, the combination of the organic resin and chemical activator may be heated and then pumped to a mixer where the components are mixed to form the coating of the coating system. The mechanisms used to heat, pump and mix the components will be readily appreciated by those skilled in the art. An example of an adjustable-ratio proportioner specifically designed for applying high solids protective coatings is the Graco Hydrocat™ HP supplied by Graco Inc. 88-11th Avenue NE, Minneapolis, Minn. 55413 USA.

The third step of the method comprises coating the metal substrate with the epoxy composition.

Mechanisms that are suitable to apply the coating include, but are not limited to, sprayers, brushes, trowels, and knives, among others. Roll coating may be useful when applying the coating to sheet metal. The coating may be sprayed onto the substrate with a sprayer. This method is useful for applying the coating to the interior of a metal pipe. To aid in spraying the coating, it may be desirable to manipulate the substrate in a manner that allows for even and thorough coverage by the coating.

The epoxy primer coating may be a monolayer of the primer and have an average thickness of about 0.001 to about 0.02 inch (0.025 mm to 0.5 mm), preferably about 0.008 to about 0.018 inches (0.20 mm to 0.46 mm). Typically good adhesive properties are observed between ionomer and epoxy primer at even 0.001 inch thick primer coating on steel. An epoxy coating that is just 0.001 inch thick typically requires the use of a solvent or thinner to reduce of the viscosity of the two part epoxy. However, thicker coatings provide better corrosion resistance and may be useful to minimize variability of adhesion due to surface irregularities. It is difficult to prepare epoxy coatings with thicknesses greater than 0.015 inch (0.4 mm) in a single application.

After the coating is applied to the substrate, it is partially cured to form a thin layer of the epoxy on the metal substrate. Curing, as described herein, includes the process by which a liquid or semi-solid resin hardens or becomes solidified. In the method, the coating is kept at a temperature, preferably ambient temperature, for a period of time so that it is partially cured. As used herein, “partially cured” is a condition in which the epoxy coating composition exhibits an exotherm below 150° C. when heated above its glass transition temperature, determined by differential scanning calorimetry according to ASTM D3417.

The cure behavior of epoxy coatings is explained in a number of articles and textbooks. Two references for epoxy curing are Chemistry and Technology of Epoxy Resins, edited by Bryan Ellis, Blackie Academic and Professional, an imprint of Chapman and Hall, 1993. Chapter 2 of the Ellis reference is titled Curing Agents for Epoxy Resins. The second reference is Epoxy Resins Chemistry and Technology Second Edition, edited by Clinton A. May, Marcel Dekker Inc., 1988. Chapter 7 of the May reference is titled “Epoxy Resin Adhesives”. Section IV.A. of that chapter deals with curing agents for epoxy adhesives. These sources explain that amine curing agents are generally used for ambient cured adhesives. However, there are amine based curing agents like dicyanodiamide that are solids at room temperature and typically used for formulating one component epoxy coating where the epoxy base and high temperature activated activator can be powder coated onto the prepared steel and then heat activated to form a coating. Both the May and the Ellis references indicate the degree of epoxy cure can be estimated by the Tg or glass transition temperature of the coating. The higher the Tg the greater the degree of cure. Both references refer to polyoxypropyleneamines as useful activators for the epoxy formulas used in ambient cure adhesives. The Ellis reference states the higher molecular weight versions of polyoxypropyleneamines have an inconveniently slow rate of cure. As a consequence, high molecular weight polyoxypropyleneamines are often used in combination with other amine activators to accelerate the rate of cure. Certain accelerators, including aminophenols such as 2,4,6 tris(dimethylaminomethyl)phenol, may adversely impact the strength of the bond between the epoxy and the ionomer. Aminosilanes may also reduce bond strength. Thus, epoxy compositions for bonding with the ionomer liner material preferably do not contain aminophenols or aminosilanes.

In a paper published by Double Liaison—Physique & Chimie Des Peintures & Adhesifs, Groupe ETAI, Volume 5, No 547 October 2005, Mager et al, used digital scanning calorimetry (DSC) analysis to investigate the rate of cure of epoxy urethane systems. The authors noted that an exotherm at a temperature above the glass transition temperature indicates an incomplete degree of cure. Without being bound by any particular theory, incomplete or partial cure may be due to the restricted mobility of the molecular components during the curing time.

Preferably partial curing is conducted at ambient temperature, and no heating or cooling is applied to the coated substrate. The temperature may be from about 0° C. to about 40° C., preferably from about 20° C. to about 30° C.

The time is selected to allow for partial curing of the epoxy coating, as defined above and is dependent on the particular epoxy system used.

The maximum cure time may be chosen somewhat arbitrarily to accommodate a practical production schedule, provided that an exotherm is observed above the glass transition temperature of the epoxy system.

The minimum time necessary for partially curing the epoxy primer also depends on the particular epoxy system used. The liner could be applied shortly after the substrate is coated with the epoxy primer so that very little curing could have occurred. However, practical considerations suggest that a reasonable amount of curing is desirable prior to insertion of the liner. For ease of handling, the coating is desirably cured at ambient temperatures to a condition where it is not sticky to the touch, but not fully cured. ASTM D 1640 defines “dry to the touch” and “dry hard” for paint finishes. Partial cure for a coating system can be determined as the state in which the coating is “dry-to-touch” or “dry-hard” according to ASTM D1640, yet exhibits an exotherm on heating above its glass transition temperature. Prior to inserting the preformed ionomer liner into the epoxy primed pipe it is preferable to have the epoxy coating dry to touch or more preferably dry hard to minimize the drag or resistance between coated pipe and liner as the liner is inserted into the prepared pipe.

A sample of epoxy coating may be cured at ambient temperature for a period of time and analyzed by DSC to determine if an exotherm is observed above its glass transition temperature, but below 150° C. Once a suitable time interval is found for a sample of a given epoxy system, the temperature may be predetermined for subsequent applications. Depending on the cure rate, the epoxy coating may be cured at ambient temperature for between one hour and 30 hours. The time may range from about one hour to about 24 hours, such as from 5 hours to 20 hours.

It is noted, however, that other factors may cause the curing processes of the coating to occur at temperatures outside of these ranges and in a time period that is shorter and or longer than the range provided herein.

After the epoxy coating has had time to partially cure, it is contacted with an ionomer liner material. The ionomer liner may comprise a single layer of an ionomer composition or it may be a multilayer liner. A multilayer liner of note comprises a first surface layer of an ionomer composition that is adhered to the epoxy-primed metal, a second surface layer of an ionomer composition that is an abrasion resistant layer and at least one interior layer of a material selected from the group consisting of thermoplastic resin (including an additional ionomer layer different from the abrasion resistant layer and/or the adhesive layer), fiber reinforcement, thermoset resin and metal.

The terms “thermoplastic ionomer polymer” and “ionomer”, and similar terms used herein, refer to a thermoplastic ionomer made from a parent acid copolymer comprising, consisting essentially of, or prepared from copolymerized units of an α-olefin, copolymerized units of an α,β-ethylenically unsaturated carboxylic acid, and optionally copolymerized units of a softening comonomer wherein at least a portion of the carboxylic acids are neutralized to provide salts with a metal ion.

The acid copolymers used to make the ionomer compositions described herein are preferably random acid copolymers. In random copolymers, at least some of the atoms comprising the copolymerized monomers are part of the polymer backbone or chain. In contrast, in graft copolymers, a grafted group is attached to non-terminal repeat units in an existing polymer chain, often by a subsequent free radical reaction, and the atoms comprising the group are not part of the polymer backbone.

The acid copolymers are preferably an α-olefin, particularly ethylene, α,β-ethylenically unsaturated carboxylic acid, particularly acrylic acid or methacrylic acid, copolymer, optionally containing a third softening monomer. “Softening” means that the polymer is made less crystalline.

Acid copolymers may be described as E/X/Y copolymers where E represents copolymerized units of ethylene, X represents copolymerized units of a C₃₋₈ α,β-ethylenically unsaturated carboxylic acid, preferably acrylic acid or methacrylic acid, and Y represents copolymerized units of a softening comonomer selected from alkyl acrylate or alkyl methacrylate, wherein the alkyl groups have from 1 to 8 carbon atoms, or vinyl acetate. X is present in an amount of about 2 to about 30 (or about 2 to 25 or about 2 to 20, or about 5 to 25) weight % of the E/X/Y polymer, and Y is present in from 0 to 45 weight % of the E/X/Y copolymer.

Preferably E/X/Y terpolymers are used as the precursor polymers for ionomers used in the wear and/or adhesive layers of a multilayer liner structure. Included are E/X/Y terpolymers in which X represents copolymerized units of methacrylic acid and Y represents copolymerized units of an alkyl methacrylate or preferably an alkyl acrylate and is present in an amount from 3 to 45 weight % of the E/X/Y terpolymer (preferably from a lower limit of 3 or 5 or more preferably 10, to an upper limit of 25, 30 or 45). These terpolymers include without limitation ethylene/methacrylic acid/methyl acrylate, ethylene/methacrylic acid/ethyl acrylate, ethylene/methacrylic acid/iso-butyl acrylate, and preferably ethylene/methacrylic acid/n-butyl acrylate terpolymers.

Similarly, terpolymers may include copolymerized units of acrylic acid in about 2 to about 30 (or about 2 to 25 or about 2 to 20, or about 5 to 25) weight % of the E/X/Y polymer, and copolymerized units of alkyl methacrylate or alkyl acrylate in an amount from 3 to 45 (preferably from a lower limit of 3 or 5 or more preferably 10, to an upper limit of 25, 30 or 45) weight % of the E/X/Y terpolymer.

Of note are E/X/Y terpolymers, wherein X (e.g. acrylic acid or preferably methacrylic acid) is present in an amount from 5 to 20% of the copolymer and Y (e.g. alkyl acrylate such as butyl acrylate) is present in an amount from 10 to 45% of the copolymer.

Also of note are dipolymers, preferably used for ionomers in an interior core layer of a multilayer structure) that may be described as E/X dipolymers (wherein Y is 0 weight % of the E/X/Y copolymer), including without limitation, ethylene/acrylic acid dipolymers or ethylene/methacrylic acid dipolymers. Of note are E/X dipolymers wherein X is present in an amount of 5 to 25 weight % of the dipolymer.

The parent acid copolymers may be polymerized as disclosed in U.S. Pat. Nos. 3,404,134; 5,028,674; 6,500,888; and 6,518,365.

They may be neutralized as disclosed in U.S. Pat. Nos. 3,264,272 and 3,404,134 to salts comprising metal ions. The ionomers may be neutralized to any level that does not result in an intractable (not melt processible) polymer without useful physical properties. The ionomers are neutralized so that from about 5 to about 90%, or preferably from about 15 to about 90%, more preferably about 40 to about 75% of the acid moieties of the acid copolymer are neutralized to form carboxylate groups, based on the total carboxylic acid content of the parent acid copolymers as calculated for the non-neutralized parent acid copolymers.

Preferred counterions for the carboxylate groups include alkali metal cations, alkaline earth metal cations, transition metal cations, and combinations of two or more of these metal cations. The metal ions may monovalent, divalent, trivalent, multivalent, or mixtures thereof. When the metallic ion is multivalent, complexing agents such as stearate, oleate, salicylate, and phenolate radicals may be included, as disclosed in U.S. Pat. No. 3,404,134. The metallic ions are preferably monovalent or divalent metallic ions.

Preferred cations useful in the ionomers include lithium, sodium, potassium, magnesium, calcium, or zinc, or combinations of two or more of these cations. More preferably, the metallic ions are selected from the group consisting of sodium, lithium, magnesium, zinc and mixtures thereof, yet more preferably, sodium, zinc and mixtures thereof. Most preferably, the metallic ions are zinc.

Preferably, an ionomer composition used as an adhesive layer in a multilayer liner structure (the outermost layer of a tubular pipe liner) has a melting point of about 60 to about 220° C., preferably about 60 to about 80° C., preferably from about 65 to about 75° C. Preferably, it has flexural modulus determined at 21° C. according to ASTM D790 of less than or equal to 90 MPa and Shore D hardness (ASTM D2240, ISO 868) from about 30 to about 50.

The soft ionomer in the abrasion resistant wear layer of the liner (innermost layer of the pipe liner) may have Shore D hardness (ASTM D2240, ISO 868) from about 30 to about 50, notably about 30 to about 45. The composition may have Shore A value of less than 90. The ionomer of this layer may have a flexural modulus determined at 21° C. according to ASTM D790 of less than or equal to 90 MPa, such as in a range from 25 to 80 MPa, preferably from 25 to 60 MPa. The ionomer composition used in the wear layer in the multilayer liner structure has a melting point of about 60 to about 220° C., such as 60 to about 80° C., notably from about 65 to about 75° C.

A notable ionomer used in the wear layer consists essentially of an E/X/Y terpolymer containing 23.5 weight % of n-butyl acrylate and 9 weight % of methacrylic acid based on the total weight of the parent acid terpolymer, the remainder ethylene, wherein at least a portion of the carboxylic acid groups are neutralized to salts of zinc ions. This ionomer is also useful as an adhesive layer for bonding to epoxy-coated metal substrates.

If an ionomer is used as an interior layer of a multilayer liner structure, preferably the ionomer is based on a ethylene acid dipolymer and has a melting point of about 75 to about 150° C., preferably about 80° C. to 120° C. or higher, most preferably about 85° C. or higher. The composition desirably has a flexural modulus determined at 21° C. according to ASTM D790 of greater than 80 MPa, preferably greater than 200 MPA. The interior ionomer layer provides the high thermal resistance to the liner required by many demanding uses. To serve as a moisture barrier, the composition has a moisture vapor permeation value less than 2 g-mil/100 in²-day, preferably below 1.5 g-mil/100 in²-day, or lower.

A notable ionomer used in an interior layer consists essentially of an E/W dipolymer containing 15 weight % methacrylic acid based on the total weight of the parent acid dipolymer, the remainder ethylene, wherein at least a portion of the carboxylic acid groups are neutralized to salts of zinc ions.

Suitable ionomer materials are available commercially from E.I. du Pont de Nemours, Wilmington, Del. (DuPont) under the Surlyn® tradename.

The ionomer compositions may include additives known in the art. The additives include plasticizers, processing aids, flow enhancing additives, flow reducing additives, lubricants, flame retardants, impact modifiers, nucleating agents to increase crystallinity, antiblocking agents such as silica, thermal stabilizers, UV absorbers, UV stabilizers, dispersants, surfactants, chelating agents, coupling agents, adhesives, primers and the like. One of ordinary skill in the art will recognize that additives may be added to the ionomer composition using techniques known in the art or variants thereof, and will know the proper amounts for addition based upon typical usage. The total amount of additives used in the composition may be up to about 15 weight % based upon the weight of the ionomer composition.

When used in an interior layer of a multilayer liner structure, a dipolymer ionomer composition may further comprise about 0.1 to about 80 weight % filler based on the total weight of the filled composition. Such fillers are described in greater detail in copending application U.S. Ser. No. 61/449,762.

The ionomer composition can be formed into generally planar films and sheets, or tubular films and pipes by methods known in the art that can be used as an abrasion resistant liner or protective covering. In general, sheets and pipes are thicker and stiffer than films and tubular films, respectively. The ionomer liners may comprise a single layer of ionomer, or they may be multilayer structures.

For example, the multilayer structure may have three or more layers, in which each of the surface layers comprises an ionomer, and at least one interior layer which may or may not comprise an ionomer.

An interior layer comprising an ionomer of an ethylene acid dipolymer or a polyethylene homopolymer, polyethylene copolymer, polypropylene homopolymer or polypropylene copolymer may provide bulk to the structure, or may modify the properties of the structure, such as providing enhanced moisture barrier.

A notable multilayer structure comprises a first surface layer comprising an ionomer of an ethylene acid terpolymer, an interior layer comprising an ionomer of an ethylene acid dipolymer, and a second surface layer comprising an ionomer of an ethylene acid terpolymer.

The liner may be a complex multilayer structure of, in order, a first layer of ionomer or acid copolymer resin adhesive capable of bonding to the epoxy-primed steel, a first tie layer to bond the adhesive ionomer or to high density polyethylene (HDPE) or polypropylene (PP), a second tie layer and a second layer of ionomer as a wear layer. The tie layers bond the high density polyethylene (HDPE) or polypropylene (PP) to the ionomer layers. By adding a layer of HDPE or PP to the structure water permeation can be reduced in a much thinner liner structure.

In such multilayer structures, the surface layers may comprise the same ionomer composition or different ionomer compositions. Additionally, the surface layers may have different thicknesses, depending on their function. For example, one surface layer may be thicker and serve as an abrasion-resistant layer and the other surface layer may be thinner and serve as an adhesion layer to bond with the epoxy-coated substrate.

An ionomer film or sheet and the multilayer ionomer film or sheet may be produced by any method known in the art. Preferably the film or sheet is produced through melt processes, such as extrusion or coextrusion blown film processes, extrusion or coextrusion film or sheet melt casting processes, sheet profile extrusion or coextrusion processes, lamination processes, extrusion coating processes, calendar processes and the like. The films and sheets may undergo secondary formation processes, such as the plying together of preformed sheets to produce thicker sheets through thermal lamination.

Additional details of multilayer liners that are suitable for use in the methods described herein are disclosed in copending application U.S. Ser. No. 61/449,762.

The epoxy-coated substrate is placed in contact with the ionomer liner material such that the ionomer and the epoxy coating are adjacent to form a multilayer overlay. As used herein, a “multilayer overlay” comprises layers of materials wherein at least one layer is in contact with at least one other layer but is not bonded or adhesively attached to that other layer. Additional layers may be bonded or adhesively attached to the layers that are in contact but not bonded or adhesively attached. For a generally planar epoxy-coated metal substrate, a film or sheet comprising an ionomer layer may be placed on the substrate contacting the epoxy coating to provide a multilayer overlay.

A terpolymer ionomer composition may be part of a multilayer structure comprising a first surface layer comprising the terpolymer ionomer composition in contact with the layer of partially cured epoxy composition and a second surface layer comprising an ionomer of an ethylene acid terpolymer. An interior layer may comprise an ionomer of an ethylene acid dipolymer or a polyethylene homopolymer, polyethylene copolymer, polypropylene homopolymer or polypropylene copolymer.

An ionomer-lined metal pipe may be prepared by pulling or inserting a preformed ionomer tube or multilayer ionomer tube comprising an ionomer composition as described above into an epoxy-coated metal pipe wherein the outer diameter of the ionomer tube is slightly less than the interior diameter of the metal pipe. Alternatively, a method to produce an ionomer-lined metal pipe comprises laying up an ionomer film or sheet or multilayer ionomer film or sheet into an epoxy-coated metal pipe. Either method will provide a multilayer overlay in which the ionomer composition is in contact with a layer of partially cured epoxy composition.

Applying heat and optionally pressure to the multilayer overlay will completely cure the epoxy composition and bond the ionomer to the metal substrate.

For generally planar multilayer overlays, application of heat and pressure may be accomplished using a heated press. The substrate and ionomer liner material are laid up in overlying fashion in a press and heat and pressure applied. In some cases the press may be heated prior to inserting the substrate-ionomer overlay.

We have found that a combination of higher pressures and higher temperatures may give the most consistent bond. However, to minimize costs and complexity, it may be desirable to perform the bonding operation at lower temperatures and/or pressures that are still capable of providing bonds of sufficient strengths for a particular end use.

The substrate-ionomer overlay may be heated to the temperature range of about 120 to about 400° C., preferably to the temperature range of about 120 to about 300° C. and most preferably to the temperature range of about 120 to about 225° C.

In a heated press, hydraulic pressure can be applied, but in bonding of liners to pipe, pneumatic pressure is preferred. For bonding using pneumatic pressure, above 15 psi the bonding process would fall under rules regulating pressure vessel or fittings. Upper pressure is limited by pressure vessel/fitting codes and the tendency of the liner to flow under conditions of high temperature and pressure. Consequently, to minimize the complexity of the bonding process, it is preferred to bond at pressures less than 15 psi (103 kPa).

Alternatively, for some metal substrates, the epoxy-coated substrate and the ionomer liner material may be placed in contact and passed through heated nip rolls.

Alternatively, molten ionomer liner material may be (co)extrusion coated onto the epoxy-coated substrate. Alternatively, a liner material may be laminated to the epoxy-coated substrate by applying a molten ionomer composition between the liner material and the epoxy-coated substrate. Small epoxy-coated substrates may be overmolded with molten ionomer liner material by injection molding or compression molding. In these embodiments, the heat necessary to completely cure the partially cured epoxy composition is provided by the molten ionomer composition as it cools and bonds to the epoxy composition. For (co)extrusion coating or lamination, pressure may be applied using nip rolls. In overmolding, pressure is normally applied to force the molten ionomer composition to conform to the shape of the mold surrounding the substrate.

The method to produce an ionomer-lined metal pipe includes the following embodiments.

The method comprises (i) coating a layer of an epoxy composition onto the inside surface of the metal pipe; (ii) partially curing the epoxy composition; (iii) pulling or inserting an ionomer tube or multilayer ionomer tube into the epoxy-treated metal pipe; (iv) heating the metal pipe above the softening point of the ionomer composition; and (v) allowing the metal pipe to cool.

The method comprises (i) coating a layer of an epoxy composition onto the inside surface of the metal pipe; (ii) partially curing the epoxy composition; (iii) laying up the interior of a metal pipe with ionomer film or sheet or multilayer ionomer film or sheet; (iv) heating the metal pipe above the softening point of the ionomer composition; and (v) allowing the metal pipe to cool.

The metal pipe may be heated using an oven, a furnace, a gas ring burner, electrical resistive heating elements such as strap heaters, radiant heaters, induction heating, high frequency electrical heaters and the like.

In either embodiment, a bladder may be inserted inside the ionomer-pipe overlay to hold the ionomer in place inside the pipe. Inflating the bladder provides pressure to keep the ionomer liner material from sagging and losing contact with the epoxy composition during heating. Alternatively the ends of the ionomer liner tube may be capped and low pressure applied to the inside of the liner tube.

An example ionomer lined metal pipe method with an ionomer sheet includes descaling the interior of the metal pipe, followed by degreasing and cleaning. The interior of the pipe is treated with the epoxy coating and the epoxy is partially cured at ambient temperature as described above. The interior of the epoxy coated metal pipe is then covered with the ionomer sheet, preferably with the sheet overlapping onto itself 0.5 to 4 inches to form a seam. The seam may be heat fused or the excess sheet may be trimmed and the sheet ends may be heat fused, as desired. The metal pipe is then heated, as described above, to the temperature range of about 120 to about 400° C., preferably to the temperature range of about 120 to about 300° C. and most preferably to the temperature range of about 120 to about 160° C. As the metal pipe-ionomer sheet structure heats, the epoxy-coated metal pipe makes intimate contact with the outside surface of the ionomer sheet, causing it to soften and adhere to the inside surface of the epoxy-coated metal pipe.

For example, preparing an ionomer lined metal pipe method with an ionomer tubular liner includes descaling, degreasing and cleaning the pipe as described above. The epoxy coating is applied to the pipe and partially cured. An ionomer liner is placed inside the epoxy-coated pipe. The metal pipe is then heated, as described above, to the temperature range of about 120 to about 400° C., preferably to the temperature range of about 120 to about 300° C. and most preferably to the temperature range of about 120 to about 160° C. As the pipe-ionomer liner structure heats, the epoxy-coated metal pipe makes intimate contact with the outside surface of the ionomer liner, causing it to soften and adhere to the inside surface of the epoxy-coated metal pipe.

The pipes described herein provide high abrasion-resistance and corrosion resistance for the conveyance of solids and slurries such as found in the agriculture, food and mining industries. The ionomer layer in the pipes provides very long lifetime, especially desirable for those industries that require long service lifetime due to the great maintenance and replacement complexity and cost. For example, oil slurry mining operations require kilometers of slurry pipelines in extreme environments, such as northern Alberta, Canada, so extended pipe lifetime is very desirable. Other mining operations that include the transport of highly abrasive particulate or slurry streams from the mine to processing refinery include, for example, iron ore, coal and coal dust, and the like, and in further non-mining transport processes, such as grain, sugar and the like.

### EXAMPLES

The following Examples are intended to be illustrative of the invention, and are not intended in any way to limit its scope.

Melt Index (MI) was measured by ASTM D1238 at 190° C. using a 2160 g mass, unless indicated otherwise. A similar ISO test is ISO 1133. Shore D hardness was measured according to ASTM D2240, ISO 868.

### Materials Used

ION-1: a poly(ethylene-co-n-butylacrylate-co-methacrylic acid) containing 23.5 weight % n-butylacrylate and 9 weight % methacrylic acid based on the total weight of the parent acid terpolymer, the carboxylic acid groups neutralized to about 51 mole % to salts of zinc ions, with an MI of about 0.6 to 0.8 g/10 min and a Shore D hardness of 40.
ION-2: a poly(ethylene-co-methacrylic acid) with 15 weight % methacrylic acid, the carboxylic acid groups neutralized to about 58 mole % to salts of zinc ions with MI of about 0.7 g/10 min and Shore D hardness of 64.
Epoxy-1: a two-part chemically-cured epoxy semi-gloss coating where the activator and base are blended at a 1:5 volume ratio, sold as Bar-Rust® 235 epoxy by Devoe High Performance Coatings, Strongsville, Ohio.
Epoxy-2: an epoxy/urethane two part epoxy primer where the activator (or hardener) and base are blended at a volume ratio of 1 part activator to 3 parts hardener, sold as SP-2888RG by Specialty Polymer Coatings, #101 20529 62nd Avenue, Langley BC V3A 8R4.
Epoxy-3: an undiluted clear difunctional bisphenol A/epichlorohydrin derived liquid epoxy resin, sold as Epon™ 828 by Hexion.
CA-1: an amidoamine with a low viscosity, low imidazoline content, and dark color based on tall oil fatty acid and polyamines sold as Epikure™ Curing Agent 3010 by Hexion.
CA-2: a low viscosity, modified polyamide epoxy curing agent based on dimerized fatty acid and polyamines sold as Epikure™ Curing Agent 3155 by Hexion.
AEP: Aminoethylpiperazine, CAS number 140-31-8, sold by Alfa Aesar.
DETA: Diethylenetriamine, CAS number 111-40-0, sold by Alfa Aesar.
IPDA: Isophorone diamine CAS number 2855-13-2, supplied by DuPont.
PODA-1: Polyoxypropylenediamine, CAS number 9046-10-0, sold as Jeffamine® D230 by Huntsman International LLC, P.O. Box 4980, The Woodlands, Tex. 77387.
PODA-2: Polyoxypropylenediamine, CAS number 9046-10-0, sold as Jeffamine® D400 by Huntsman.
Silica: Fumed Silica, CAS number 112945-52-5, supplied by Sigma Aldrich.
DMP-30™: 2,4,6 tris(dimethylaminomethyl)phenol (CAS 90-72-2), supplied by Sigma Aldrich.
AEPTMS: N-[3-(trimethoxysilyl)propyl]ethylenediamine (CAS 1760-24-3), supplied by Sigma Aldrich.

Thickness and diameter in the following tables, unless specifically indicated, are in inches (1 inch=2.54 cm).

A 0.1 inch (2.5 mm) thick wear layer (one monolayer layer of ION-1), a 0.23 inch (6.3 mm) thick interior layer made up of two plies of the monolayer film of ION-2 and then a ply of the coextruded ION-2/ION-1 film and then finally a 0.07 inch (1.8 mm) thick adhesive layer of ION-1.

Two processes were used to prepare the nominally 0.4 inch (10 mm) thick liner used in the adhesion tests.

In the first process, monolayer 0.1 inch (2.5 mm) thick by nominally 20 inch (500 mm) wide sheets of ION-1 and ION-2 were extruded into sheets separately. A third sheet, 20 inch (500 mm) wide, was made by coextruding ION-1 and ION-2 into a two layer structure with an overall thickness of 0.1 inch (2.5 mm) where 70% of the thickness was made up of an ION-1 layer and 30% of the thickness was made up of an ION-2 layer. Subsequently, individual sheets were stacked on top of each other and then thermally laminated together to build up a 0.4 inch thick sheet. A MPL-24 HC thermal laminator made by Glenro, Inc 1100 E 3rd Street, Maysville, Ky. 41056 was used to bond adjacent layers. Typical operating conditions were a belt speed of 0.3 m/min., a nip pressure of 0 to 200 kPa and heater temperatures of 170 to 180° C. On the first pass through the laminator, two monolayer films of ION-2 were bonded together. Then a layer of ION-1 was added to the bottom of the stack and the structure passed through the laminator a second time. On the third pass, the previously laminated sheet was flipped over and the co-extruded sheet was added to the bottom of the stack so that the ION-2 layer on the co-extruded sheet was in contact with ION-2 in the stack. This liner sheet comprised a 0.1 inch (2.5 mm) thick “wear” layer of ION-1, a 0.23 inch (6.3 mm) thick interior layer made up of ION-2 and a 0.07 inch (1.8 mm) thick “adhesive” layer of ION-1. The laminated sheet, in random lengths from 1 meter to 3 meters by 500 mm wide, was trimmed using a bandsaw to give squares or rectangles for either bonding onto plates or rolling or seaming into tubes.

A liner material was also prepared using a cast sheet co-extrusion process to make an “A-B-A” co-extrusion with one extruder melting and pumping the “A” layers comprising ION-1 and a second extruder melting and pumping the “B” layer comprising ION-2. The sheet extrusion equipment was supplied by Welex Incorporated (1600 Union Meeting Rd 200 Industrial Blvd, Blue Bell, Pa. 19422 USA) fitted with a Cloeren die supplied by Cloeren Incorporated, 401 16th Street, Orange, Tex. 77630 U.S.A. The line had a 6-inch single screw extruder with gear pump feeding the core “B” layer of the feed block and a 4.5-inch single screw extruder feeding the “A” surface layers. The Cloeren die was externally deckled from 130 inches to about 90 inches. The upward travelling vertical stack had 32-inch diameter chrome rolls. The 90-inch (228 cm) wide coextruded sheet, produced at 1.2 ft/min (0.37 m/min), was in-line trimmed to 1.84 meter wide sheet that had an “adhesive” layer nominally 0.09-inch thick (2.3 mm) layer of ION-1, a 0.2-inch thick (5 mm) interior or core layer of ION-2 and a second surface “wear” layer of ION-1 that was 0.09 inch (2.3 mm) thick.

In all examples, the liner material was positioned so that the “adhesive” layer faced the prepared steel layer.

### Comparative Examples C₁-C₂ and Examples 3-7

In each of these Examples, a 0.25 inch (6.4 mm) thick cold rolled steel plate 6 inch by 6 inch (152 mm by 152 mm) in dimension was sandblasted on one side to white metal and wiped clean with paper towels. Within 24 hours of sandblasting and cleaning, the steel plate was bonded to a 0.4 inch (10 mm) thick by 6 inch by 6 inch (152 mm by 152 mm) piece of the ionomer liner described above using the Plate Bonding Procedure described below.

### Plate Bonding Procedure

A Carver press sold by Carver Inc., 1569 Morris St. PO Box 544, Wabash, Ind. 46992-0544, was used to bond the ionomer liners to the prepared steel plates. The top platen was set at 190° F. (88° C.) and the bottom platen set at 303° F. (150° C.). Test assemblies were assembled from top to bottom: fluoropolymer coated release cloth sheet, steel plate, liner material with the adhesive layer facing the plate, and fluoropolymer coated release cloth sheet. The assembly was put into the press, with the steel plate facing down. A 2600-gram aluminum block (nominally 152 mm by 152 mm by 30 mm) was placed on top of the upper release sheet. The press was closed and tightened until the gauge registered 600 lbf (2669 N) which was one of the smallest scale increments on the inside black scale on the gauge attached to Carver Press. The platen area of the press is 81 in² (0.052 m²) and the steel plate/liner bonding area was 36 in² (0.0232 m²) so a force of 600 lbf (2669 N) generated by the press provided a pressure at the ionomer/prepared steel interface of 600 lbf/36 in² or about 17 lbf/in² (115 kPa). The sample was heated for 8 minutes. The press was opened and the aluminum block was removed. The sample, kept between the release sheets, was removed and placed between two room temperature aluminum blocks and allowed to slowly cool for 5 minutes.

Table 1 provides a summary of temperature readout and bonding time for a run. The data were used to estimate the interface temperature between the epoxy coated steel and ionomer liner during the bonding process in the Carver Press. The maximum temperature reached in this test was 138° C. Presuming that there are slight sample to sample variations in the installation of the thermocouples, the maximum interface temperature was assumed to be about 140° C.

TABLE 1

| Time | Temperature | | Time | Temperature | | Time | Temperature | |
|---|---|---|---|---|---|---|---|---|
| (min- | (° C.) | | (min- | (° C.) | | (min- | (° C.) | |
| utes) | Plate | Liner | utes) | Plate | Liner | utes) | Plate | Liner |
| 0.5 | 66 | 56 | 3 | 120 | 109 | 6 | 134 | 131 |
| 1 | 88 | 72 | 3.5 | 125 | 114 | 6.5 | 135 | 132 |
| 1.5 | 101 | 86 | 4 | 128 | 118 | 7 | 136 | 133 |
| 2 | 110 | 95 | 4.5 | 130 | 124 | 7.5 | 137 | 134 |
| 2.5 | 116 | 103 | 5 | 132 | 127 | 8 | 138 | 135 |
| | | | 5.5 | 133 | 130 | | | |

### Adhesion Testing

The resulting liner bonded to the plate was then cut into 1 inch (25.4 mm) wide by 6 inch (152.4 mm) long test coupons. By clamping the coupon in a vise and then driving a chisel between the liner and the steel it was possible to peel back the first approximately 50 mm of liner from the steel backing along the 152 mm length. With the tab exposed, the coupon was loaded into an Instron Model 33R4469 (sold by Instron Worldwide Headquarters, 825 University Ave, Norwood, Mass. 02062-2643), equipped with a load cell set at 2000 lb (8896 N), tension cell and crosshead speed set at 4.0 inch/min (102 mm/min). The coupon was clamped in place horizontally and the exposed tab pulled vertically to approximate a 90° peel. The reported bond strength was the approximate average force exerted on the tension cell to maintain the 102 mm/min crosshead speed over 50 mm of peel.

Thermal Analysis

Digital Scanning calorimetry (DSC) was conducted according to ASTM D3417 from −20° C. to 260° C. at a heating rate of 10° C./min for heating and cooling. The formulated two part epoxy coatings were mixed at ambient temperature and within 10 minutes were cooled in liquid nitrogen. The cooled samples were stored in a freezer set at −20° C. Prior to loading into the thermal analyzer, the sample was allowed to warm until it softening sufficiently so that a sample could be removed to load into the analyzer. The warming time was less than 30 minutes.

### Comparative Example 1

The liner was in direct contact with the steel plate, with no intervening primer treatment. The liner and the plate were treated according to the Plate Bonding Procedure. In the adhesion testing, there was no measurable bond between liner and sandblasted steel plate.

### Comparative Example 2

The steel plate was prepared and then roll coated with Epoxy-1 using 4 parts (by volume) of base to 1 part hardener. The epoxy coating thickness was nominally 0.01 inch (0.25 mm) thick. After being cured overnight at ambient temperature, the plate was bonded to the liner according to the Plate Bonding Procedure. There was no measurable bond between liner and sandblasted steel plate.

Epoxy-1 as a 4:1 ratio of base and hardener was characterized by DSC analysis after cold storage described above. On the first heat a Tg inflection at 48° C. was observed and on the second heat a Tg inflection at 52° C. was observed. There was no evidence of an exotherm on the first heat until 216° C. where the area under the peak was estimated to be 31 J/g.

### Example 3

The steel plate was prepared and then roll coated with Epoxy-2 using the 3:1 volume ratio of base to hardener. The epoxy coating thickness was nominally 0.01 inch (0.25 mm) thick. After being cured overnight at ambient temperature, the plate was bonded to the liner using the Plate Bonding Procedure. The average peel strength was 188 lbf/in (836 N/25 mm).

DSC analysis on the formulated Epoxy-2 at the 3:1 ratio of base and hardener showed on the first heat a Tg of 12.3° C. and an exotherm with a peak temperature of 92° C. The area under the exotherm was estimated to be 116 J/gm. On the second heat a Tg of 80° C. was observed.

These examples show at the selected ionomer liner to steel plate bonding conditions that in the absence of an epoxy primer, a poor bond (in Comparative Example 1 no measureable bond occurred between liner and steel) occurs. In the case of Comparative Example 2, the epoxy primer applied to the steel plate had an exotherm on heating of 216° C., which is well above the maximum temperature at the interface between steel and ionomer during bonding. No measureable bond was measured between the liner and the epoxy-1 coated steel plate. In the case of the primer used in example 3, an exotherm occurred on the first heat with a peak temperature of 92° C. and an exotherm size of 116 J/gm. The peak exotherm occurred at a temperature below the maximum temperature measured at the interface between ionomer and epoxy coated steel of approximately 140° C. The bond between liner and epoxy coated steel plate in example 3 was 836 N/25 mm.

### Examples 4 and 5

In these examples, epoxy adhesive formulations were prepared from the Epoxy-3 liquid epoxy base and different amine catalysts. The weight of epoxy base and the weight of catalyst were chosen so that there would be enough amine to react with all of the epoxy (stoichiometric ratio). Epoxy-3 is reported by Hexion to have weight per epoxide of 185 to 192 g/equivalent. We used 188.5 g/equivalent in our calculations. For example, in Example 4, 100 grams of Epoxy-3 works out to 0.53 epoxy equivalents. AEP has 43 amine equivalents in 100 g. so we calculated that 22.8 grams of AEP were required to react with 100 grams of Epoxy-3.

The liquid epoxy and amine were stirred together on a weight basis and then roll coated onto the steel plate. The epoxy coating thickness was nominally 0.01 inch (0.25 mm) thick.

Initially, on the plate coated with Epoxy-3 and DETA (Example 5), “sweat” appeared to form on the roll coated plate after several hours of curing. This phenomenon is called amine blush and is discussed in some detail by Bruce L. Burton from Huntsman Corporation in a talk titled “Amine-Blushing Problems? No Sweat!”, presented at the Fall 2001 Epoxy Resin Formulators' Meeting of The Society of the Plastics Industry.

TABLE 2

| | Component (parts in g) | | |
|---|---|---|---|
| Example | Epoxy-3 | AEP | DETA |
| 4 | 100 | 22.8 | |
| 5 | 100 | | 10.9 |

After being cured overnight at ambient temperature, the plate was bonded to the liner using the Plate Bonding Procedure. The peel results and DSC results from Examples 4 and 5 are summarized in Table 3.

TABLE 3

| | | | DSC Analysis | | | |
|---|---|---|---|---|---|---|
| | T-Peel Result | | First Heat (° C.) | | | |
| Exam- | (N/25 | | | Exotherm | Second Heat(° C.) | |
| ple | mm) | (lbs/in) | Tg | Peak | Tg | Exotherm |
| 4 | 867 | 195 | 52 | major 107 | 110 | none |
| 5 | 173 | 39 | 60 | none | 89 | none |

Very high bond strengths were found with the epoxy coating systems used in Example 4. The bond strength between liner and the coating used in Example 5 was marginal. Both epoxy systems were found to be dry to the touch after overnight curing, but not fully cured, based on DSC analysis. For Example 4, the DSC analysis on the first heat scan showed that an exotherm was present above the observed Tg but below the maximum temperature used to bond the liner to the epoxy-coated steel. For Example 5, the DSC analysis showed there was no significant exotherm on heating.

### Examples 6 Through 19

When first applied to the prepared steel plate, the epoxy blends of Examples 4 and 5 made a smooth coating on the steel surface but as the coating underwent ambient curing, the coating tended to coalesce resulting in a very patchy epoxy coating. Hexion product literature has suggested adding two weight % fumed silica to Epoxy-3. The fumed silica is reportedly a thixotropic agent that increases the viscosity of the coating at low or zero shear.

A blend comprising 600 grams of Epoxy-3 and 12 grams of fumed silica was prepared on a Hamilton Beach Commercial Blender model 1C911 (Hamilton Beach/Proctor Silex Washington NC 27889). The fumed silica and epoxy base were mixed for about a minute initially to develop a uniform dispersion. Prior to removing material from the blender, the mixture was blended again for 10 to 20 seconds. The blend of Epoxy-3 and fumed silica is referred to in the tables as “Blend A”. Blend A was mixed with various amine curing agents as summarized in Table 4. “Equivalent weight” is in the case of the Blend A (corrected for presence of 2 weight % of fumed silica), per mole of epoxy units. In the case of the amines it is the weight of activator required to react with one mole of epoxy units.

TABLE 4

| | Component | | | | | | |
|---|---|---|---|---|---|---|---|
| | “Blend A” | AEP | PODA-1 | PODA-2 | IPDA | CA-1 | CA-2 |
| | Equivalent weight (g) | | | | | | |
| Exam- | 185 | 43 | 60 | 115 | 42.6 | 95 | 133 |
| ple | Parts by weight (g) | | | | | | |
| 6 | 57 | 13 | | | | | |
| 7 | 60 | 11 | | | | | |
| 8 | 62 | 8 | | | | | |
| 9 | 53 | | 14.5 | | | | |
| 10 | 53 | | 17 | | | | |
| 11 | 52 | | 20.5 | | | | |
| 12 | 57 | | | | 13 | | |
| 13 | 50 | | | | | 20 | |
| 14 | 40 | | | | | | 22.5 |
| 15 | 43 | | | 26 | | | |
| 16 | 43 | 5 | | 21 | | | |
| 17 | 43 | 5 | | 26 | | | |
| 18 | 50 | | | | | 20 | |
| 19 | 40 | | | | | | 23 |

Blend A and the cure agents were stirred together on a weight basis and then roll coated onto steel plates. The epoxy coating thickness was nominally 0.01 inch (0.25 mm) thick.

After being cured at ambient temperature for the times indicated, the plates were bonded to the liner using the Plate Bonding Procedure. Since the fumed silica was added to the epoxy blends all of the coatings in Examples 6 through 19 made smooth coatings on the plate and stayed smooth during the cure. The peel results and DSC results from Examples 6 through 17 are summarized in Table 5. In Table 5, “NM” indicates “not measured”, “E/I” indicates that the peel occurred between the epoxy and ionomer layers, and “E/S” indicates the peel occurred between the epoxy and steel layers.

TABLE 5

| | t-Peel Results (N/25 mm) | | | DSC Analysis | | | |
|---|---|---|---|---|---|---|---|
| | Cure time | | Peel | First Heat | | | Second Heat |
| Exam- | before bonding | | Inter- | Tg | Exotherm Peak | | Tg |
| ple | 4 h | 24 h | face | (° C.) | (° C.) | (J/g) | (° C.) |
| 6 | 37 | 102 | E/S | None | 99 | 368 | NM |
| 7 | NM | 685 | E/I | 5 | 104 | 248 | 105 |
| 8 | NM | 135 | E/I | None | 103 | 217 | NM |
| 9 | NM | 1054 | E/I | None | 125 | 378 | 73 |
| 10 | NM | 742 | E/I | None | 126 | 412 | 81 |
| 11 | NM | 480 | E/I | None | 127 | 405 | 66.4 |
| 12 | 547 | 218 | E/I | None | 111 | 456 | 150 |
| 13 | NM | 285 | E/I | None | 117 | 153 | none |
| 14 | NM | 198 | E/I | None | 133.9 | 146 | 76 |
| 15 | NM | 1522 | E/I | None | 139.6 | 339 | 50 |
| 16 | NM | 1134 | E/I | None | 125 | 296 | none |
| 17 | NM | 365 | E/S | None | 120 | 163.7 | none |
| 18 | 184 | 113 | E/I | NM | | | |
| 19 | 71 | 129 | E/I | NM | | | |

Example 6 had a composition similar to Example 4 yet the peel strength was substantially lower for Example 6 than for Example 4. In most examples with strong bonds (greater than 356 N/25 mm or 80 lbf/in) the peel occurred between the ionomer liner and the epoxy. We found that for samples with AEP as the activator, where low peel values occurred (such as Example 6) the peel occurred between the epoxy and the steel. That is, the epoxy stayed bonded to the ionomer but released cleanly from the steel. By reformulating the base to activator ratio so that less activator was added to the composition than would be required by the stoichiometric ratio of amine to epoxy it was possible to maintain a peel at the epoxy/ionomer interface. Examples 7 and 8 show the effect of using 80% and 57% of the AEP necessary to provide a stoichiometric ratio of amine to epoxy. The 80% stoichiometry provided strong bonds (685 N/25 mm) and the peel was at the epoxy/ionomer interface. At 57% stoichiometry, the peel was at the epoxy ionomer interface, but the peel strength was a relatively low 135 N/25 mm.

Similarly Examples 9, 10 and 11 show the effect of using 80%, 100% and 120% of the stoichiometric ratio of a polyoxypropylenediamine (PODA-1) to Epoxy-3. In Example 9, 80 equivalent % PODA-1 provided a bond of 1054 N/25 mm. In Example 10 the addition of 100% of PODA-1, for a stoichiometric ratio of activator to base, provided a bond of 742 N/25 mm. In Example 11, increasing the loading of PODA-1 to 120% of the stoichiometric ratio substantially decreased the bond strength relative to Examples 9 and 10. Without being bound by any particular theory, too much activator appears to inhibit good bonds between the epoxy coating at the ionomer liner even though the thermal properties of the epoxy coating containing more activator may have an exotherm on heating that is less than the interface temperature during bonding.

Example 12 used isophorone diamine as the activator at the stoichiometric ratio of activator to base. This activator base combination cures relatively rapidly, resulting in a stronger bond between the epoxy and liner after just four hours of curing rather than 24 hours of curing. Thermal analysis of the IPDA/Epoxy-3 blend shows a very high Tg, 150° C., on the second heat. In some applications (for example a lined water service pipe), it may be advantageous to formulate an epoxy primer coating that cures sufficiently at ambient conditions to provides a strong bond between ionomer and epoxy coated steel and also develops a high Tg prior to going into service.

Examples 13 and 14 included two amine activators, CA-1 and CA-2 at the 80% nominal ratio of activator to epoxy base. Previous testing with these activators at the 100% stoichiometric ratio of activator to base had shown low bond strengths, where the peel was at the epoxy/steel interface. The bond strengths in Example 14 and 15 also were low, 285 N/25 mm and 198 N/25 mm respectively, but at the 80% stoichiometric ratio the peel was at the ionomer/epoxy interface.

Examples 15, 16 and 17 illustrate the effect of blending amine activators. ASTM D 1640 defines “dry to the touch” and “dry hard” for paint finishes. In Example 15, using polyoxypropylenediamine PODA-2, the coating was not dry to the touch (i.e. there was still some transfer of the coating to the finger tip) after 24 hours, but bond strength was very good. In Example 16, 21 grams, or 80% of the stoichiometric ratio of PODA-2, was added to 43 grams of Epoxy-3. A second amine activator, AEP, was added at 50% of the stoichiometric ratio of amine to base. The addition of the AEP to the predominantly PODA-2 activator mix promoted more rapid curing of the epoxy. Combining AEP with PODA-2 provided a dry to touch time at ambient conditions of 24 hours. The coating used in Example 16 provided bond strength of 1135 N/25 mm. In Example 17 PODA-2 was added at 100% of the stoichiometric ratio of amine to epoxy and then an additional 5 grams, or 50 equivalent % of AEP was added. Twenty-four hours after application, the coating was dry to the touch but the resulting bond strength was relatively low (365 N/25 mm) and the peel was at the epoxy/steel interface.

In Examples 18 and 19, the prepared steel plate was roll coated with Blend A and CA-1 and CA-2 at the 80% of the stoichiometric ratio of activator amine to epoxy in the base. These coating compositions are the same as Examples 13 and 14. In Examples 18 and 19, two plates were coated with each epoxy blend recipe. The ionomer liner was bonded to one plate after 4 hours of curing and the second plate was bonded to the ionomer liner after 24 hours of curing. With the CA-1 and CA-2 activators in the epoxy blend at the 80% stoichiometric ratio, the strength of the bond between ionomer and epoxy coated steel was better when bonded after four hours relative to 24 hours. The measured bond strength on the Example 18 plates and Example 19 plates after 4 or 24 hours remained low.

Another blend, “Blend B”, comprising Epoxy-3, 2 weight % of fumed silica, and 3 weight % of TiO₂ was prepared similarly. Blend B was mixed with IPDA or PODA-2 and additional amine components as summarized in Table 6. DMP-30™ is an example of aminophenols that are known to accelerate curing of epoxy compositions. AEPTMS is an aminosilane.

TABLE 6

| | Component | | | | |
|---|---|---|---|---|---|
| | Blend B | PODA-2 | DMP-30 ™ | IPDA | AEPTMS |
| Equivalent | 175 | 115 | | 42.6 | |
| weight (g) | | | | | |
| Example | Parts by weight % | | | | |
| 20 | 40 | 26 | 0 | | |
| 21 | 40 | 26 | 6 | | |
| 22 | 40 | 26 | 12 | | |
| 23 | 50 | | | 12 | 0 |
| 24 | 50 | | | 12 | 6 |
| 25 | 50 | | | 12 | 12 |

Blend B and the cure agents were stirred together on a weight basis and then roll coated onto steel plates. The epoxy coating thickness was nominally 0.01 inch (0.25 mm) thick. After being cured at ambient temperature for the times indicated, the plates were bonded to the liner using the Plate Bonding Procedure. The results of t-peel tests are reported in Table 7. All peels occurred at the epoxy/ionomer interface.

TABLE 7

| | | | DSC Analysis | | | |
|---|---|---|---|---|---|---|
| | t-Peel Results (N/25 mm) | | First Heat | | | Second Heat |
| Exam- | Cure time before bonding | | Tg | Exotherm Peak | | Tg |
| ple | 4 h | 24 h | (° C.) | (° C.) | (J/g) | (° C.) |
| 20 | NM | 433 | None | 143 | 316 | none |
| 21 | NM | 165 | None | 130 | 292 | None |
| 22 | NM | 0 | NM | NM | NM | NM |
| 23 | 409 | NM | none | 113 | 447 | 143 |
| 24 | 101 | NM | NM | NM | NM | NM |
| 25 | 0 | NM | None | 109 | 372 | 112 |

The results in Table 7 show that aminophenols or aminosilanes can reduce the bond strength to the ionomer. The higher the concentration, the greater the loss in bond strength occurred.

In addition to the examples shown above, we also prepared blends of activators, base and relatively high boiling diluents including naphtha, benzyl alcohol, dimethyl carbonate and reactive diluents like neopentyl glycol diglycidyl ether. Only minor, perhaps insignificant, reductions in the bond strength were observed with the addition of the diluents or reactive diluents to the coating formula.

Liner Tubes Bonded to Steel Pipe

### Materials Used

The steel pipe used in the following Examples was “6-inch” welded steel pipe, sandblasted to white metal and wiped clean prior to epoxy coating. Dimensions for this type of pipe have an outer diameter (OD) of 6.625 inches and an inner diameter (ID) of 6.343 inches, according to the IPT's Pipe Trades Handbook by Robert Lee, published by IPT Publishing and Training Ltd Edmonton Alberta, February 2008.

The liner sheet prepared as described above was cut into a rectangle with various lengths with the width controlled to 18 to 18.75 inches (457 to 476 mm). The sheet was then rolled widthwise and then extrusion welded where the edges touched to seam the rolled sheet into a tube with a nominal outside diameter of 6.25 inches (159 mm). An extrusion welder (available from Wegner Welding, 16W301 S. Frontage Rd., Burr Ridge, Ill. 60527) and rod shaped pieces of ION-1 were used to seam the two edges of the rolled sheet.

The seamed liner was approximately 3 inches (76 mm) longer than length of pipe spool to allow 1.5 inch (38 mm) to extend out of each end of the steel spool. The liner OD was slightly smaller than the ID of the epoxy coated steel pipe. Since the pipe ID was 6.3 inches (160 mm), the liner OD was about 6.25 inches (159 mm).

### Bladder Bonding Process

Materials Used in the Bladder Bonding Process:

Rubber bladder 4.5 inch (114 mm) OD×4 inch (102 mm) ID rubber tubing (reference part no #800161) available from Tidland Corporation, 2305 SE 8th Avenue, Camas, Wash. 98607. The bladder comes with metal endcaps, one of which has a fitting that permits inflating the bladder.

Corrosion-resistant Viton® rubber sheet, 0.25 inch (6.4 mm) thick and of varying length, the width selected to match the ID of the liner tube. Sixteen inch (406 mm) wide sheet was used for the 6-inch diameter steel pipe.

Fluoropolymer coated release cloth.

Strap heater that tightly fit to outside of 6-inch diameter pipe (OD 6.63 inch). The heater was 12 to 18 inches long, 120 V, 1200 W.

A Barnant Controller Model 689-0010 was used to control the temperature of the strap heater.

The liner, release cloth, rubber sheet and bladder (listed from outside to inside) were assembled inside the coated pipe spool. The strap heater was attached around one end of steel pipe and connected to the temperature controller. A thermocouple taped or clamped to the surface of the steel pipe under the area heated by the strap heater was used to measure the temperature.

The bladder was inflated to 10 to 12 psig (69 to 83 kPa). The power to the strap heater was turned on and the set-point on the Barnant Controller set at 150° C. to heat the steel pipe. Once the actual steel pipe temperature reached the set-point temperature of 150° C., the temperature was held for another 25 to 60 minutes. After the elapsed hold time, the controller was turned off and the power supply to controller and heater was unplugged. The strap heater was moved one full strap heater length down the pipe and the heating and holding process was repeated until the entire length of steel pipe between the flanges had been heated.

### Adhesion Testing

The liner bonded to pipe was cut into 1 foot (305 mm) lengths and then ripped in half lengthwise using a Hyd-Mech S-20 series 2 Horizontal Band Saw. Then a 1 inch (25.4 mm) wide strip was removed from one edge of the half pipe. The 12 inch (305 mm) long by 1 inch (25.4 mm) wide strip was cut in half to give two 6 inch (152 mm) by 1 inch (25.4 mm) test coupons. By hand the first two inches of liner were peeled away from the epoxy coated steel by clamping the coupon in a vise and then using a chisel or screw driver to separate the liner from the epoxy coated steel coupon. Once the first two inches of liner were separated from the coupon, an Instron Model 33R4469 peel tester was used to measure the force required to peel the remaining 4 inches (102 mm) of liner from the epoxy coated steel plate using a cross head speed of 4 inches/min (102 mm/min).

### Comparative Example C8

A 15.5 inch (394 mm) length of 6-inch steel pipe was sandblasted, cleaned and then epoxy coated by roll coating with Epoxy-1 at the 4:1 base to hardener volume ratio. The epoxy was allowed to cure overnight prior to bonding to the liner. To bond the liner to the epoxy-coated steel a strap heater set-point of 150° C. with a hold time of 60 minutes was used. No measureable bond was found between the liner and the epoxy-coated steel on the coupon removed form this pipe.

### Example 29

15.5 inch (394 mm) length of 6-inch steel pipe was sandblasted, cleaned and then epoxy coated by spray coating with Epoxy-2 at the 3:1 base to hardener volume ratio. To reduce the viscosity for spray coating, to the 3 to 1 blend of Base and hardener an additional one part of dimethyl carbonate was added. The spray coated pipe was allowed to partially cure overnight prior to bonding to the liner. To bond the liner to the epoxy coated steel, a strap heater set-point of 150° C. with a hold time of 60 minutes was used. Two 1 inch (25.4 mm) wide coupons were removed and tested for bond strength. The first coupon had an average bond of 240 lbf/in (1068 N/25 mm). The second coupon was found to have an average bond of 200 lbf/in (890 N/25 mm).

1. A method for bonding ionomer compositions to a metal substrate comprising:
(a) providing a metal substrate;
(b) providing an epoxy composition;
(c) coating the metal substrate with the epoxy composition;
(d) partially curing the epoxy composition at ambient temperature for a period of time sufficient to produce a layer of partially cured epoxy composition that exhibits an exotherm below 150° C. when heated, determined by differential scanning calorimetry according to ASTM D3417;
(e) contacting the layer of partially cured epoxy composition with an ionomer composition to provide a multilayer overlay;
wherein the ionomer composition comprises an E/X/Y copolymer where E represents copolymerized units of ethylene, X is present in an amount of about 2 to about 30 weight % of the E/X/Y polymer and represents copolymerized units of a C₃₋₈ α,β-ethylenically unsaturated carboxylic acid, and Y is present in from 0 to 45 weight % of the E/X/Y copolymer and represents copolymerized units of a softening comonomer selected from alkyl acrylate, alkyl methacrylate, wherein the alkyl groups have from 1 to 8 carbon atoms, or vinyl acetate, and wherein at least a portion of the carboxylic acid groups in the copolymer are neutralized to salts containing alkali metal cations, alkaline earth metal cations, transition metal cations, or combinations of two or more of these metal cations;
(f) applying heat and optionally pressure to raise the temperature of the multilayer overlay to at least 50° C. above the melt temperature of the ionomer thereby achieving intimate contact of the ionomer with the partially cured epoxy composition, additionally curing the epoxy composition and bonding the ionomer to the epoxy coated metal substrate.

2. The method of claim 1 wherein the epoxy composition comprises an epoxy/urethane organic resin.

3. The method of claim 1 wherein the epoxy composition comprises a reaction product of bisphenol A and epicholorohydrin.

4. The method of claim 3 wherein the epoxy composition comprises a cycloaliphatic amine as a chemical activator.

5. The method of claim 4 wherein the cycloaliphatic amine comprises aminoethylpiperazine.

6. The method of claim 3 wherein the epoxy composition comprises a polyamine as the chemical activator.

7. The method of claim 6 where the polyamine is a polyoxypropylenediamine.

8. The method of claim 1 wherein the E/X/Y copolymer comprises Y in an amount from 3 to 45 weight % of the E/X/Y copolymer.

9. The method of claim 8 wherein the ionomer composition is part of a multilayer structure comprising
(a) a first surface layer comprising the ionomer composition in contact with the layer of partially cured epoxy composition,
(b) an interior layer comprising an ionomer of an ethylene acid dipolymer, and
(c) a second surface layer comprising an ionomer of an ethylene acid terpolymer.

10. The method of claim 8 wherein the ionomer composition is part of a multilayer structure comprising
(a) a first surface layer comprising the ionomer composition in contact with the layer of partially cured epoxy composition,
(b) an interior layer comprising a polyethylene homopolymer, polyethylene copolymer, polypropylene homopolymer or polypropylene copolymer, and
(c) a second surface layer comprising an ionomer of an ethylene acid terpolymer.

11. An article comprising:
(a) a metal substrate;
(b) an epoxy layer directly adhered to the metal substrate; and
(c) an abrasion resistant multilayer structure comprising an adhesive ionomer layer comprising an ionomer of an ethylene acid terpolymer in contact with and directly adhered to the epoxy layer on the face opposite the metal substrate; an interior layer comprising an ionomer of an ethylene acid dipolymer or a polyethylene homopolymer, polyethylene copolymer, polypropylene homopolymer or polypropylene copolymer; and an abrasion resistant ionomer surface layer comprising an ionomer of an ethylene acid terpolymer.

12. The article of claim 11 wherein the epoxy composition comprises an epoxy/urethane organic resin.

13. The article of claim 11 wherein the epoxy composition comprises a reaction product of bisphenol A and epicholorohydrin.

14. The article of claim 13 wherein the epoxy composition further comprises a cycloaliphatic amine.

15. The article of claim 14 wherein the cycloaliphatic amine comprises aminoethylpiperazine.

16. The article of claim 11 wherein the epoxy composition comprises a polyamine as the chemical activator.

17. The article of claim 16 where the polyamine is a polyoxypropylenediamine.

18. The article of claim 11 wherein the interior layer is an ionomer of an ethylene acid dipolymer.

19. The article of claim 11 wherein the interior layer is a polyethylene homopolymer, polyethylene copolymer, polypropylene homopolymer or polypropylene copolymer, further comprising tie layers between the interior layer and the adhesive ionomer layer and between the interior layer and the abrasion resistant ionomer surface layer.

20. The article of claim 11 wherein the metal substrate is a pipe and the abrasion resistant multilayer structure is on the inside surface of the pipe.

21. The article of claim 20 that is used to transport oil slurry.

22. The article of claim 11 wherein the metal substrate is a pipe and the abrasion resistant multilayer structure is on the outside surface of the pipe.
